(19) United States
(12) Patent Application Publication
(10) Pub. No.: US 2018/0023248 A1
(43) Pub. Date: Jan. 25, 2018

(54) Lubricious Silicone Cable Jackets and Cable Assemblies Formed Therefrom

(71) Applicant: Tyco Electronics Corporation, Berwyn, PA (US)

(72) Inventors: Stephen V. Davis, Oregon City, OR (US); Robert Lee Beckman, Beaverton, OR (US); Iver Skye Olsen, Portland, OR (US)

(21) Appl. No.: 15/217,782

(22) Filed: Jul. 22, 2016

(51) Int. Cl. D07B 1/16; C09D 183/04

(52) U.S. Cl. CPC D07B 1/162; C09D 183/04

(57) ABSTRACT

A silicone cable jacket and a cable assembly formed therefrom exhibits lubricious properties. The silicone cable jacket includes a silicone elastomer and a PSQ additive. The PSQ additive is selected as a polyalkylsilsesquioxane, a polyarylsilsesquioxane, a polyalkylaryl-silsesquioxane, or a mixture thereof. The silicone cable jacket exhibits a lower static and dynamic coefficient of friction (COF) as measured according to ASTM D 1894-14 and an enhanced level of abrasion resistance in a DIN 53516 test as compared to a similar cable jacket without the PSQ additive.

### FIELD

The present disclosure relates to silicone cable jackets that exhibit lubricious properties. More specifically, this disclosure relates to cable assemblies that incorporate said silicone cable jackets in order to provide a surface having a high level of lubricity and an enhanced level of abrasion resistance.

### BACKGROUND

The statements in this section merely provide background information related to the present disclosure and may not constitute prior art.

Silicone rubber is widely used throughout the medical industry as a cable jacket and as an over mold material for forming flex relief structures thereon. Reusable surgical device cables require excellent bonding and resistance to high temperatures and chemical sterilization techniques and/or equipment commonly used in hospitals, such as autoclaves. Resistance to extreme heat and high humidity encountered during sterilization may also be relatable to the environmental requirements for other applications in the automotive, aerospace, and marine industries. Silicone rubber offers excellent chemical and thermal resistance properties as well as biocompatibility that greatly surpass the capabilities of other materials commonly used in cable jackets, such as polyurethane or polyvinyl chloride (PVC).

However, silicone rubber also is naturally “tacky” to the touch and offers only a low level of abrasion resistance. End users in hospital environments are critical of the surface feel for many reasons. First, since cable assemblies are most often hand-held during surgical procedures, tackiness is a highly undesirable property. Second, sterilization and reprocessing of cable assemblies require that cable jackets to be routinely cleaned. A tacky cable jacket will attract dust and dirt resulting in surgical devices that are difficult to clean and sterilize. Third, the cut resistance of a cable jacket is also extremely important when used in an operating room due to the presence of sharp surgical tools (i.e. scalpels).

Vapor deposited poly(p-xylylene) polymer coating processes have been used to mitigate the tackiness of silicone rubber. These materials, sold under the trade name Parylene, provide a conformal coating which provides a lubricious surface feel and withstands sterilization. However, the Parylene coating also enhances the visibility of any cosmetic flaw on the surface of the silicone. In addition, the Parylene coating will develop stress marks as a silicone cable is flexed. This results in customer complaints I concerns about the cosmetic appearance of the assembly.

In addition, although Parylene adheres to a silicone elastomer, it does not allow for the subsequent application and bonding of a Parylene or a silicone over-mold material. The inability to coat Parylene or a silicone on top of a previously coated cable eliminates the possibility of re-working a cable assembly. It is a common occurrence for cable assemblies in surgical products to require such rework. Due to these issues, scrap becomes a significant cost factor related to the Parylene process. In fact, the cost of applying a Parylene coating to a cable is about 3 to 4 times more expensive than applying a silicone elastomeric cable jacket.

U.S. Publication No. 2015/0075841 by M. Driener of Leoni Kabel Holding GmbH discloses a silicone article, such as a cable with a silicone outer jacket, that is improved with respect to its feel and particularly its coefficient of friction is reduced. Solid mica particles are introduced into the surface of the cable or other article. An intermediate product which has a silicone-type base material on the exterior is initially provided in a state that is not, or no more than partially, cross-linked. The solid material particles are subsequently pressed in, before the complete cross-linking takes place. The solid material particles are present only in the surface region.

U.S. Pat. Nos. 5,960,245 and 6,302,835 (Davis et al.) disclose a material for coating an imaging member comprising a cross-linked poly(dialkylsiloxane) and a silicone T-resin and/or zirconium silicate. The zirconium silicate may be present in an amount from 10 to 150 weight parts per 100 weight parts of cross-linkable poly(dialkylsiloxane).

### SUMMARY

The present disclosure generally provides a silicone cable jacket that exhibits lubricious properties. The cable jacket comprises a silicone elastomer and a PSQ additive. The PSQ additive may include, but not be limited to polyalkylsilsesquioxanes, polyarylsilsesquioxanes, polyalkylarylsilses-quioxanes, or mixtures thereof. The PSQ additive may include, without limitation, polymethylsilsesquioxane, polyethylsilsesquioxane, polypropylsilsesquioxane, polyphenylsilsesquioxane, polymethylphenylsilsesquioxane, polyethylphenylsil-sesquioxane, or a mixture thereof. Alternatively, the PSQ additive is polymethylsilsesquioxane. The PSQ additive is incorporated into the cable jacket in an amount within the range of about 10 wt. % to about 30 wt. % based on the overall weight of the cable jacket. Optionally, the PSQ additive may comprise one or more hydroxyl- or alkoxy-functional groups. When desirable, the PSQ additive may be cross-linked with the silicone elastomer.

The silicone elastomer is a high consistency rubber (HCR) or a liquid silicone rubber (LSR); alternatively, the silicone elastomer is a high consistency rubber (HCR). According to another aspect of the present disclosure, the cable jacket further comprises a layer of a liquid silicone rubber (LSR) that at least partially encapsulates the silicone elastomer and is bonded thereto.

The silicone cable jacket with the PSQ additive exhibits at least a 30% reduction in weight loss in a DIN 53516 test as compared to a similar cable jacket without the PSQ additive. The cable jacket with the PSQ additive also exhibits a lower static and dynamic coefficient of friction (COF) as measured according to ASTM D 1894-14 than a similar cable jacket without the PSQ additive. In fact, the static COF of the cable jacket with the PSQ additive is at least 25% lower than the static COF of a similar cable jacket without the PSQ additive. Alternatively, the cable jacket with the PSQ additive exhibits at least a 50% reduction in weight loss in a DIN 53516 abrasion test, at least a 40% lower static coefficient of friction (COF) as measured according to ASTM D 1894-14, and a decrease in tear resistance by less than 35% in an ASTM D 624-00(12) test as compared to a similar cable jacket without the PSQ additive.

According to another aspect of the present disclosure, a cable assembly is provided. The cable assembly comprises a cable and the cable jacket described above and further defined herein. This cable assembly passes at least 150 cycles of autoclave conditioning without the occurrence of any bonding defects between the cable jacket and the cable. The cable assembly may be used in applications that include, but are not limited to, medical, automotive, aerospace, defense, or marine applications.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1A is a scanning electron micrograph (SEM) Images at 500X magnification of the surface of a cable jacket prepared according to the teachings of the present disclosure.

FIG. 1B is a scanning electron micrograph (SEM) Images at 500X magnification of the surface of a comparable cable jacket.

FIG. 2A is a perspective view of a silicone cable assembly prepared according to the teachings of the present disclosure over molded with a flex relief.

FIG. 2B is a perspective view of a comparable silicone cable assembly over molded with a flex relief.

FIG. 3A is a schematic representation of the load measured as a function of distance in a coefficient of friction (COF) test for a silicone jacket prepared according to the teachings of the present disclosure.

FIG. 3B is a schematic representation of the load measured as a function of distance in a coefficient of friction (COF) test for a comparable silicone jacket.

FIG. 4A is a top-down perspective view of the cable jacket of FIG. 2A after 136 cycles of autoclave conditioning.

FIG. 4B is a top-down perspective view of the comparable cable jacket of FIG. 2B after 136 cycles of autoclave conditioning.

### DETAILED DESCRIPTION

The present disclosure generally relates to silicone jackets that exhibit lubricious properties and cable assemblies formed therefrom. The following description is merely exemplary in nature and is not intended to limit the present disclosure, application, or uses. For example, the lubricious silicone cable jackets made and used in accordance with the teachings contained herein is described throughout the present disclosure in conjunction with cable assemblies used with medical devices, equipment, and procedures in order to more fully illustrate the formation of the cable jackets and the use thereof. The incorporation and use of the disclosed silicone cable jackets in cable assemblies used in a variety of other applications, including but not limited to automotive, aerospace, defense, and marine applications, is contemplated to be within the scope of the present disclosure. It should be understood that throughout the description, corresponding reference numerals or letters indicate like or corresponding parts and features.

Silicone elastomeric cable jackets offer a highly robust form of packaging that is capable of being used with various medical devices. However, silicone elastomers are inherently tacky, which often results in an uncomfortable “feel” for doctors when they are used as a cable jacket. In addition, this tackiness can also act as a collector of dust and bioburden. Conventional methods of reducing surface tackiness consist of providing a surface coating, which eliminates any possibility of over-molding and/or re-work. The incorporation of a polysilsesquioxane additive (PSQ) into a silicone elastomer prior to extrusion of a silicone cable jacket according to the teachings of the present disclosure, results in a lubricious extruded surface that exhibits increased abrasion resistance, while allowing for direct over-molding and re-work.

According to one aspect of the present disclosure, the silicone cable jackets comprise, consist of, or consist essentially of a polysilsesquioxane (PSQ) resin as an additive. PSQ resins are generally cross-linked siloxane particles that correspond to the formula (RSiO_{3/2})ₙ, where R is independently selected to be an alkyl, aryl, hydrogen (H), vinyl, alkoxy, or hydroxyl group. Alternatively, the R group is independently selected as an alkyl or aryl group; alternatively, as a methyl, ethyl, propyl, or phenyl group. The subscript n may range, without limitation, from 6 to 12, thereby, providing cage-like, micro-spherical structures. The average particle size of the PSQ resins range from about 0.1 micrometers (μm) to about 50 μm; alternatively, from about 0.5 μm to about 25 μm; alternatively, from about 2μm to about 10 μm. PSQ resins are commercially available and are widely utilized by the cosmetic industry in the formulation of facial powders, creams, and anti-aging products.

This PSQ additive may include, but not be limited to, a polyalkylsilsesquioxane, a polyarylsilsesquioxane, or a polyakylarylsilses-quioxane resin. The polyalkylsilsesquioxane resin may comprise, without limitation, a polymethylsilsesquioxane resin, a polyethylsilsesquioxane resin, a polypropylsilsesquioxane resin, or a mixture thereof. The polyarylsilsesquioxane resin may include, but not be limited to polyphenylsilsesquioxane. Several specific examples of a polyalklyarylsilsesquioxane, among many different examples, include polymethylphenylsilsesquioxane and polyethylphenyl-silsesquioxane. Alternatively, the silicone cable jackets comprise a polymethylsilsesquioxane additive.

The PSQ additive may be incorporated into the silicone elastomer by any means known in the art, including, but not limited to mixing mills and internal mixers. The PSQ additive may be incorporated by directly adding the additive to the silicone elastomeric resin during the milling process, thereby, allowing the mixture of the silicone elastomer and the PSQ additive to be processed by typical extrusion or molding methods. The ability to incorporate the additive during the milling process eliminates the need for any secondary or tertiary steps to create a cable jacket having a lubricious surface.

The PSQ additive is used in a sufficient concentration to achieve a lubricious feel when applied to the silicone resin. The PSQ additive may be incorporated into the cable jacket in an amount ranging from about 1 wt. % to about 35 wt. % based on the overall weight of the cable jacket. Alternatively, the PSQ additive is incorporated into the cable jacket in an amount ranging from about 10 wt. % to about 30 wt. %; alternatively, between about 15 wt. % and about 25 wt. %; alternatively, about 20 wt. %; alternatively, less than 5 wt.%; alternatively, greater than 26 wt. %, based on the overall weight of the cable jacket.

Conventional fillers used in conjunction with a silicone resin, typically lead to reduced mechanical properties being exhibited by the silicone resin. The PQS additive, being oligomeric in nature, as well as being silicone-based, allows for a lubricous feel without causing a significant reduction in mechanical properties to be exhibited by the silicone resin. This, combined with the inherent lubricity of the additive, leads to a synergistic effect. The silicone-based nature of the additive may also lead to specific interactions (e.g., higher compatibility) with the silicone elastomer used to form the cable jacket.

According to another aspect of the present disclosure, the PSQ resin may include one or more hydroxyl-functional, vinyl-functional, and/or alkoxy-functional groups. Alternatively, the alkoxy-functional groups, may be methoxy- or ethoxy-functional groups. The hydroxyl-functional, vinyl-functional, and/or alkoxy-functional groups incorporated into the PSQ resin allows the PSQ resin to react with and become cross-linked with the silicone elastomeric resin. This cross-linking between the PSQ additive and the silicone elastomer can further reduce any effect that the PSQ additive has on the mechanical properties exhibited by the silicone elastomer.

The silicone elastomer used to form the cable jacket may comprise, without limitation, liquid silicone rubber (LSR) elastomers or high-consistency rubber (HCR) silicone elastomers. Alternatively, the silicone elastomer is a HCR silicone elastomer. The silicone elastomers generally correspond to the formula (F-1):

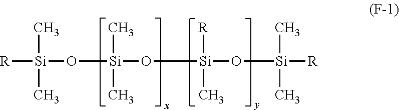

where R represents —OH, —CH═CH₂, —CH₃, or another alkyl or aryl group, and the degree of polymerization (DP) is the sum of subscripts x and y. For liquid silicone rubber elastomers, the DP of the polymers used ranges from about 10 to 1,000, which results in a molecular weight that falls within the range of about 750 to 75,000 atomic mass units (amu); alternatively, less than 5,000 amu; alternatively, between about 750 amu to less than 5,000 amu; alternatively, between about 3,000 amu to about 50,000 amu. The LSR elastomers may also exhibit a viscosity that is less than 1,000,000 mPa.s at 25° C.; alternatively less than 750,000 mPa.s at 25° C. For high consistency rubber (HCR) silicone elastomers, the DP is in the range of about 5,000 to 10,000. Thus, the molecular weight of the polymers or gums used in the high consistency rubber elastomers ranges from about 350,000 to about 750,000 or higher, resulting in viscosities that are more consistent with a gum or gum-type material.

The silicone polymers used in the formulation of these elastomers can be either a single polymer species or a blend of polymers containing different functionalities or molecular weights. The remaining ingredients of the composition are selected to conform to the R groups so that the composition may be cured into an elastomer. The HCR and/or LSR elastomers may include a single component or a two-component formulation. Several examples of commercial LSR elastomers for the production of silicone rubber products include, but are not limited to, Silastic® 7-4870 (Dow Corning Corporation, Midland, Mich.), Dow Corning® QP1 LSR, Dow Corning® Class VI LSR, or Silopren® LSR (Momentive Performance Materials, Waterford, N.Y.). Several examples of commercial HCR elastomers for the production of rubber products include, but are not limited to, Dow Corning® QP1 HCR, Dow Corning® Class VI HCR, Addisil® HRC (Momentive Performance Materials), Tufel® HCR (Momentive Performance Materials) or 23089 resin (Momentive Performance Materials), among others.

The PSQ additive is capable of allowing LSR elastomers to bond to a HSR/PSQ cable jacket (HCR silicone elastomer+PSQ additive). Thus, when desirable a LSR elastomer can also be used to over-mold a HSR/PSQ cable jacket. In other words, the silicone cable jacket further comprises, consists of, or consists essentially of a layer of a liquid silicone rubber (LSR) that at least partially encapsulates the silicone elastomer and is bonded thereto. Alternatively, the layer of LSR entirely encapsulates the surface of the silicone elastomer. An example of this type of molding operation is the over-molding of an LSR flex relief onto a HCR silicone cable jacket. The bond between the LSR elastomer and HSR/PSQ cable jacket is durable in that it is capable of withstanding repeated cycles of sterilization and/or flexing.

When desirable, the silicone cable jackets formed according to the teachings of the present disclosure may include other additives, such as those commonly incorporated into elastomeric compositions as curative systems, protective systems, reinforcing agents, cheapeners, pigments, and/or other process aids. Several examples of these additional additives may include, without limitation, hydrogenated castor oil, carbon black, and hexamethyldisiloxane. A solvent, including but not limited to xylene, may be optionally added during the mixing or milling of the silicone elastomeric resin, PSQ additive, and other additives in order to assist in dispersing the various components homogeneously throughout.

The silicone cable jackets of the present disclosure provide the benefits of: (a) lowering the tackiness of the exterior surface of the base silicone elastomer, thereby, providing a lubricious surface feel (e.g., low friction); (b) increasing abrasion resistance or resistance to cutting as compared to the base silicone elastomer; and (c) allowing for the cables jackets to be reworked along with the capability of being able to directly bond a liquid silicone rubber (LSR) over-molding to the cable jacket's outer surface. In addition, adding a PSQ additive to the silicone rubber eliminates the need for secondary processing to achieve a lubricious cable, resulting in an effective cost savings.

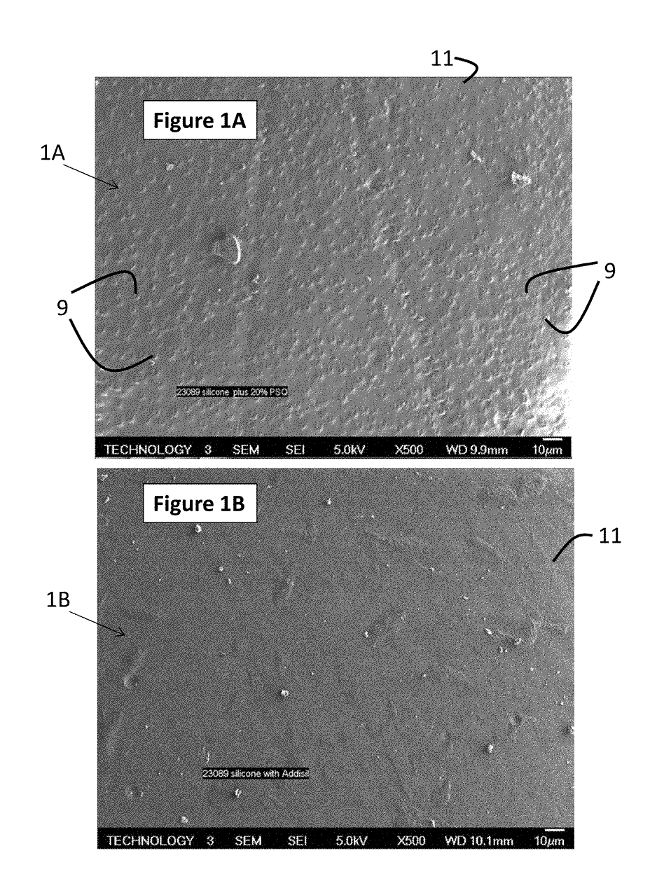

Although not wanting to be held strictly to theory, it is believed that the PSQ particles disrupt long range change entanglement and vulcanization within the silicone elastomer. Referring to FIG. 1A, the surface of the silicone cable jacket 10A prepared according to the teachings of the present disclosure as seen in a scanning electron micrograph (SEM) exhibits an isotropic distribution of the PSQ additive 9 throughout the silicone elastomer 11. In comparison, a scanning electron micrograph (SEM) as shown in FIG. 1B of the surface of a comparable cable jacket 1B exhibits only the silicone elastomer 11.

Standard test methodology for abrasion resistance, tear resistance, autoclave bond testing, and coefficient of friction may be used to quantitatively measure the corresponding properties for both comparable control cable jacket samples and cable jacket samples prepared according to the teachings of the present disclosure. For example, abrasion resistance may be measured according to DIN 53516 testing (DIN Deutsches Institut fur Normung e. V., Germany). Tear resistance may be measured according to tear resistance ASTM D 624-00(12), Die B (ASTM International, West Conshohocken, Pa.). Autoclave conditioning and bond testing may be accomplished using a TSE dry protocol with visual inspection of the bond between the cable jacket and the cable. The coefficient of friction may be tested according to ASTM D 1894-14 (ASTM International, West Conshohocken, Pa.) with slight modifications made to the fixture and procedure as described below in Example 1. One skilled in the art will understand that other comparable tests may be used to measure the properties exhibited by the silicone cable jackets without departing from the scope of the present disclosure.

The silicone cable jackets of the present disclosure, which comprise a silicone elastomer and the PSQ additive, exhibit an increase in abrasion resistance as exemplified by a decrease in amount of material that is lost as a result of the abrasion testing. The silicone cable jackets of the present disclosure exhibit at least a 30% decrease in the amount of material lost during abrasion testing as compared to a similar silicone cable jacket without the inclusion of the PSQ additive. Alternatively, the silicone cable jackets of the present disclosure exhibit at least a 50% reduction in the amount of material abraded away during abrasion testing; alternatively, about 70% or more reduction in the amount of material lost during abrasion testing as compared to similar cable jackets that do not include the PSQ additive.

Even though abrasion resistance does not directly demonstrate a resistance to cutting, it is reasonable to assume based on the abrasion results that cable jackets containing the silicone elastomer and the PSQ additive will also exhibit a higher cut resistance than the base silicone elastomer alone will. Abrasion resistance and cut resistance are properties that may impact the use of cable jackets in applications that have environments with high friction or, as in the case of operating rooms, possible exposure to cutting tools.

Although human perception of “tackiness” cannot be quantitatively measured, the measurement of the coefficient of friction (COF) provides an excellent approximation of how silicone cable jackets may be perceived by doctors in the operating room. The silicone cable jackets of the present disclosure that comprise a silicone elastomer and the PSQ additive exhibit lower dynamic and static coefficients of friction (COF) than similar silicone cable jackets that do not include the PSQ additive. The silicone cable jackets of the present disclosure exhibit at least a 10% decrease in the measured dynamic COF; alternatively, at least a 15% decrease in dynamic COF; alternatively, a decrease of about 25% or more in dynamic COF as compared to similar cable jackets that do not include the PSQ additive. The silicone cable jackets of the present disclosure also exhibit at least a 25% decrease in the measured static COF; alternatively, at least a 40% decrease in static COF; alternatively, a decrease of about 50% or more in static COF as compared to similar cable jackets that do not include the PSQ additive.

The tear resistance exhibited by the silicone cable jackets prepared according to the teachings of the present disclosure is similar to that exhibited by similar silicone cable jackets that do not include the PSQ additive. The silicone cable jackets of the present disclosure exhibit less than a 35% decrease in tear resistance as compared to silicone jackets that do not contain the PSQ additive.

According to another aspect of the present disclosure, a cable assembly is provided. This cable assembly comprises, consists of, or consists essentially of a cable and a cable jacket as previously described above and further defined herein. This cable jacket may comprise, consist of, or consist essentially of a silicone elastomer and a PSQ additive, wherein the PSQ additive is selected as one from the group of polyalkylsilsesquioxanes, polyarylsilsesquioxanes, polyalkylarylsilsesquioxanes, or a mixture thereof. The silicone elastomer may be, without limitation, a high consistency rubber (HCR) and the PSQ additive may include, but not be limited to polymethylsilsesquioxane. The PSQ additive may be incorporated into the cable jacket in an amount within the range of about 10 wt. % to about 30 wt. % based on the overall weight of the cable jacket. Optionally, the PSQ additive may include one or more hydroxyl- or alkoxy-functional groups, such that the PSQ additive and the silicone elastomer can be cross-linked.

When desirable, the cable jacket may further include a layer of a liquid silicone rubber (LSR) that at least partially encapsulates the silicone elastomer and is bonded thereto. This LSR layer may form a flex relief structure on the silicone cable jacket.

The silicone cable jackets comprising the silicone elastomer and PSQ additive of the present disclosure pass autoclave conditioning tests without exhibiting any defects at the bond line upon completion of at least 80 cycles; alternatively, upon completion of at least 150 cycles. For the purpose of this disclosure, the bond line is defined as the area in which the flex relief (cable) and the cable jacket meet. This bond line is typically the first area to de-bond when a cable is poorly bonded to a cable jacket.

Within this specification embodiments have been described in a way which enables a clear and concise specification to be written, but it in intended and will be appreciated that embodiments may be variously combined or separated without parting from the invention. For example, it will be appreciated that all preferred features described herein are applicable to all aspects of the invention described herein.

The following specific examples are given to further illustrate the preparation and testing of the silicone jackets formed according to the teachings of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure.

### EXAMPLE 1

### Preparation of Cable Jacket Samples and Cable Assemblies

Three control silicone elastomer samples (Control Nos. C1-C3) and three test samples (Run Nos. R1-R3) comprising the silicone elastomer with 20 wt. % of a PSQ additive incorporated therein were prepared. The PSQ additive incorporated into the three test samples was a polymethylsilsequioxane resin having an average particle size of between about 4μm to 6 μm.

The silicone elastomer used for the control samples (C1-C3) and the test samples (R1-R3) consisted essentially of a commercial HCR resin (23089 resin, Momentive Performance Materials, Waterford, N.Y.). The HCR resin was purchased pre-milled from the resin supplier. To formulate a cable jacket containing 20 wt. % of the PSQ additive, a two roll mill was used to distribute the PSQ additive into the pre-milled material. Great care was taken to limit thermal induced curing prior to the extrusion and compression molding process.

Samples for DIN Abrasion, Coefficient of Friction, and Tear Resistance testing were compression molded at 177° C. and 68.9 MPA. Aside from the DIN Abrasion samples which had a dwell time of 15 minutes in the mold, all test plaques were molded with a 10 minute dwell time.

All of the control and test samples (C1-C3 and R1-R3) were extruded using the same line speeds, vulcanization temperatures, and post cure processes. These samples were then stored until used to measure abrasion resistance, coefficient of friction, and tear resistance.

Similarly, six silicone cable jackets that are approximately 0.5 m length were prepared that comprised the silicone elastomer as a control (Control Nos. C4-C9) and PSQ loaded material (Run Nos. R4-R9) were over-molded with a silicone flex relief typical of a standard surgical cable on one end for use in autoclave de-bonding tests. The silicone flex relief was comprised in each case of the same commercial LSR elastomer.

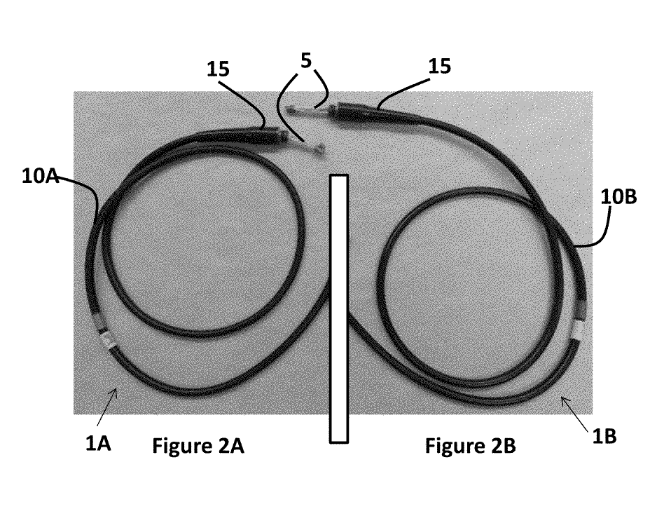

Referring to FIG. 2A, a silicone cable assembly 1A including a cable 5 and a silicone cable jacket 10A prepared according to the teachings of the present disclosure with the PSQ additive incorporated therein is shown along with a flex relief 15 over molded onto the silicone cable jacket 10A. In FIG. 2B, a comparative silicone cable assembly 1B is shown to comprise a comparative silicone cable jacket 10B without any PSQ additive along with a cable 5 and a flex relief 15 over molded onto the control silicone cable jacket 15.

### EXAMPLE 2

### Abrasion Testing

Abrasion testing was conducted in accordance with DIN 53516. Three control samples (C1-C3) and three test samples (R1-R3) prepared in Example 1 were tested. The results of the abrasion tests are summarized below in Table 1. The test samples (R1-R3), which contained 20 wt. % of the PSQ additive exhibited dramatically higher abrasion resistance. More specifically, the test samples (R1-R3) were observed to lose an average of 88 mm³ of material as compared to the control samples (C1-C3), which lost an average of 296 mm³ of material under the same conditions. Thus on average the test samples (R1-R3) in this example demonstrated about a 70% decrease in the amount of material abraded away during the test as compared to the control samples (C1-C3) tested.

TABLE 1
Summary of Abrasion Test Results

| | Initial | Final | | | | | |
|---|---|---|---|---|---|---|---|
| | Wt. | Wt. | Wt. Loss | Specific | Abrasion | Mean | Std. |
| | (g) | (g) | (mg) | Gravity | (mm³) | (mm³) | Dev. |
| C-1 | 1.617 | 1.317 | 299.6 | 1.202 | 280 | 296 | 11.3 |
| C-2 | 1.616 | 1.289 | 326.3 | | 305 | | |
| C-3 | 1.609 | 1.285 | 323.9 | | 303 | | |
| R-1 | 1.471 | 1.372 | 98.9 | 1.185 | 94 | 88 | 4.9 |
| R-2 | 1.463 | 1.370 | 93.2 | | 88 | | |
| R-3 | 1.455 | 1.370 | 86.5 | | 82 | | |

### EXAMPLE 3

### Coefficient of Friction (COF) Testing

Coefficient of friction (COF) testing was performed using a modified version of ASTM D 1894-14 using two control samples and two test samples prepared in accordance with Example 1. The COF testing was conducted using square test plaques that measured 50.8 mm on each side. Each of the test plaques was mounted on a steel plate that weighed 200 grams. Each of the test plaques was pulled at a rate of 152 mm/min across a steel reference substrate. A summary of the test results obtained in this COF testing are shown below in Table 2. The test samples (R1 & R2) that contain the PSQ additive exhibited both lower dynamic and static coefficients of friction as compared to the control samples (C1 & C2). The test samples (R1 & R2) in this Example exhibited an average reduction in the dynamic COF of about 25% and an average reduction in the static COF of about 58% as compared to the control samples (C1 & C2) that were measured.

TABLE 2
Summary of Coefficient of Friction Test Results

| | Dynamic Coefficient of Friction | | | Static Coefficient of Friction | | |
|---|---|---|---|---|---|---|
| | Result | Mean | Std. Dev. | Result | Mean | Std. Dev. |
| C-1 | 2.131 | 2.380 | 0.353 | 4.461 | 4.010 | 0.638 |
| C-2 | 2.630 | | | 3.558 | | |
| R-1 | 1.635 | 1.792 | 0.223 | 1.576 | 1.686 | 0.156 |
| R-2 | 1.950 | | | 1.797 | | |

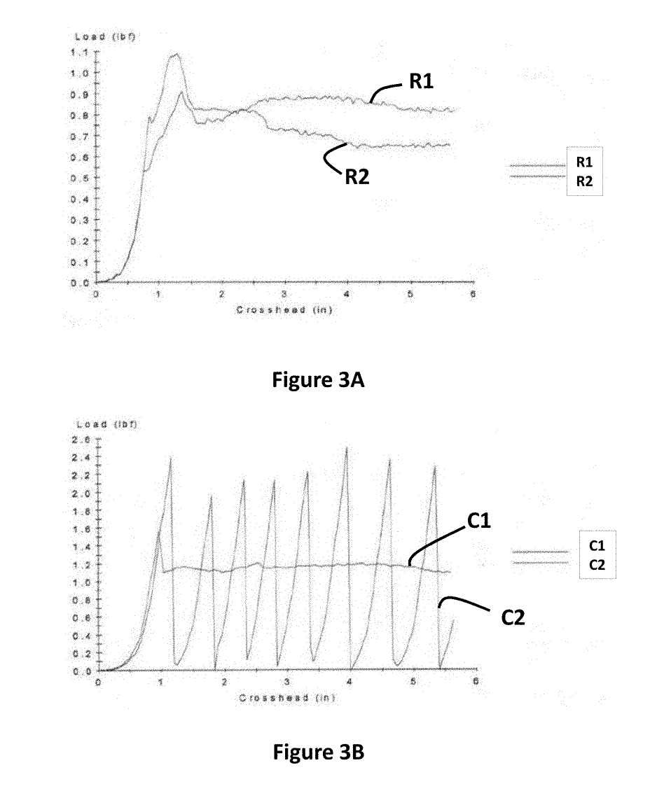

Although a dynamic coefficient of friction was determined for the control samples (C1 & C2), as shown above in Table 2, the measured data for one of the control samples (C2) was also found to demonstrate the extreme “tacky” nature of the silicone elastomer when the PSQ additive is absent. Referring now to FIG. 3A the applied load is plotted as a function displacement distance for the test samples (R1 & R2) that contain the PSQ additive. The smooth nature of the curves in FIG. 3A demonstrates the smooth displacement of the test sample over the dynamic portion of the test. In comparison, the control sample (C2) as shown in FIG. 3B was observed to exhibit an unstable transition of the load over the distance traveled during the dynamic portion of the test, indicating a high level of tackiness being exhibited by the surface of this control sample (C2).

### EXAMPLE 4

### Tear Resistance Testing

Tear resistance testing was conducted in accordance with ASTM D 624-00(12), Die B with a travel rate of 508 mm/min using three control (C1-C3) and three test samples (R1-R3) prepared in accordance with Example 1. A summary of the tear test results are summarized below in Table 3. On average, the tear resistance of the test samples (R1-R3) was observed to decrease by a mean average of 32% as compared to the control samples (C1-C3).

TABLE 3
Summary of Tear Resistance Test Results

| | Tear Strength | | |
|---|---|---|---|
| | (N/mm) | Mean Avg. | Std. Dev. |
| C-1 | 53.8 | 53.3 | 1.2 |
| C-2 | 54.5 | | |
| C-3 | 51.7 | | |
| R-1 | 34.3 | 36.6 | 2.3 |
| R-2 | 35.6 | | |
| R-3 | 39.8 | | |

Although the tear strength shows a decrease, it is not a critical factor, but more of a desirable feature because tear strength testing according to ASTM D 1894-14 is conducted on samples that are cut prior to a tensile stress being applied. In the operating room, a cable jacket which has been cut would be deemed unusable by a surgeon due to the likelihood of bio-burden contamination. What should be noted is that the increased resistance to abrasion of a PSQ loaded cable jacket would provide a superior resistance to abrasion and initiation of cutting in general. Thus cuts are believed to be less likely to occur with PSQ loaded cable jackets.

### EXAMPLE 5

### Autoclave Conditioning and De-Bonding Testing

Autoclave conditioning of the six control cable assemblies with flex reliefs (C4-C9) and six test samples with flex reliefs (R4-R9) was conducted with a standard TSE Dry Cycle using a Steris Amsco Century SV-120 autoclave steam sterilizer. During this test, all of the samples (C4-C9 & R4-R9) are exposed to 135° C. in saturated steam at a pressure of 214 kPa gage for 300 sterilization cycles with each sterilization cycle including an 18 minute sterilization time. Such test conditions reflect the common autoclave environment used for the reprocessing of surgical tools contaminated with bovine spongiform encephalopathy (BSE), transmissible spongiform encephalopathy (TSE), or Mad Cow disease. Visual inspection was conducted on each of the cable assemblies at set intervals. Particular scrutiny is paid to the bond line, where the flex relief and cable jacket meet, as it is typically the first area of de-bonding in a poorly bonded cable assembly. Each of the cable assemblies was inspected at 0, 80, and 151 autoclave preconditioning cycles.

A summary of the results measured for this autoclave conditioning de-bonding test are provided below in Table 4. The test samples (R4-R9) comprising a cable assembly prepared according to the teachings of the present disclosure that includes the silicone cable jacket with the PSQ additive were observed to perform similarly to comparable samples (C4-C9) comprising a cable assembly having a silicone cable jacket without the incorporation of any PSQ additive. In fact, none of the tested samples (R4-R9) or control samples (C4-C9) exhibited any defects at the bond line after 300 cycles.

TABLE 4
Summary of Autoclave De-Bond Test Results

| | Bond Inspection at | | | |
|---|---|---|---|---|
| | 0 Cycles | 80 Cycles | 151 Cycles | 300 Cycles |
| C-4 | No Defects | No Defects | No Defects | No Defects |
| C-5 | No Defects | No Defects | No Defects | No Defects |
| C-6 | No Defects | No Defects | No Defects | No Defects |
| C-7 | No Defects | No Defects | No Defects | No Defects |
| C-8 | No Defects | No Defects | No Defects | No Defects |
| C-9 | No Defects | No Defects | No Defects | No Defects |
| R-4 | No Defects | No Defects | No Defects | No Defects |
| R-5 | No Defects | No Defects | No Defects | No Defects |
| R-6 | No Defects | No Defects | No Defects | No Defects |
| R-7 | No Defects | No Defects | No Defects | No Defects |
| R-8 | No Defects | No Defects | No Defects | No Defects |
| R-9 | No Defects | No Defects | No Defects | No Defects |

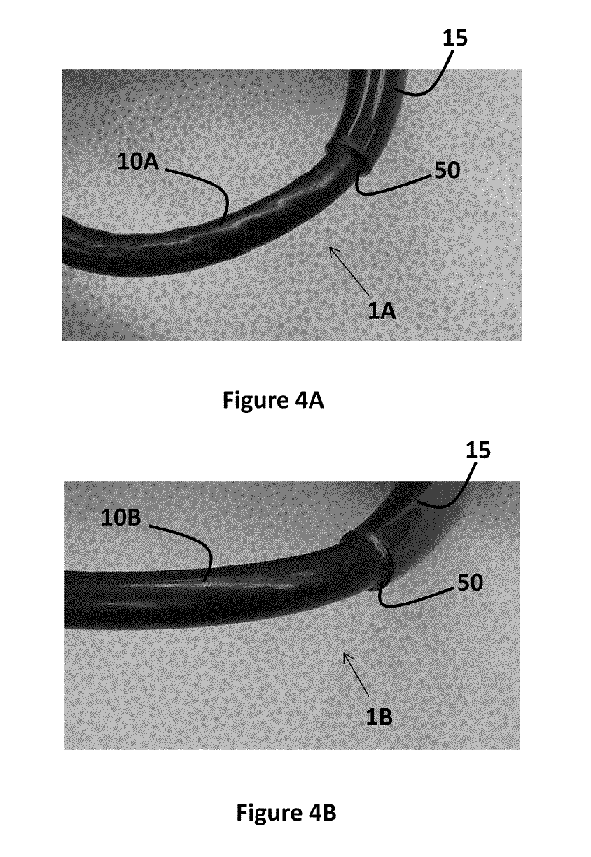

Referring now to FIG. 4A, a photomicrograph of the bond line 50 for the cable assembly 1A of the present disclosure is shown after the completion of 136 autoclave cycles. No de-bonding of the flex relief 15 from the silicone cable jacket 10A, which includes the PSQ additive is observed. Similarly, in FIG. 4B, a photomicrograph of the bond line 50 for the comparable assembly 1B is shown after the completion of 136 Autoclave cycles with no de-bonding of the flex relief 15 from the silicone cable jacket 10B being observed.

After being exposed to 300 autoclave cycles, each of the test samples (R4-R9) and comparable samples (C4-C9) were subjected to 545,000 flex cycles. For this flex test, all samples had a 454 gram (1 lb) attached to the cable jacket with the cable jacket then being bent or flexed the number of fixed flex cycles. No de-bonding of the flex relief from the silicone cable jacket was observed. This example demonstrates that bonding of an over molded LSR flex relief is possible to an extruded jacket with a lubricious feel, and that the bonds formed are capable of withstanding the most stringent of temperature and pressure cycling that reusable medical devices are subjected to.

### EXAMPLE 6

### Additional Dynamic Friction Test Measurement

This example demonstrates another test set-up and procedure for making a measurement relative to dynamic friction exhibited by the cable jacket samples in a modified ASTM D 1894-14 test method. In this example, an Instron® 5944 universal test frame with a 500 N load cell and an Instron® 2810-005 coefficient of friction fixture (with minor modifications made thereto) is utilized.

This friction test was performed by dragging a specimen across a reference surface. For this test, the bare aluminum plate of the Instron® coefficient of friction fixture was used. A pulley was used to elevate the drag line to compensate for the thickness of the sample under test. This was done because this fixture is designed for thin film testing. The reference coefficient of friction test template within the Bluehill® 3 software provided by the machine manufacturer was used in setting up this test. Prior to the start of the test, all samples were cut in half.

The process for measuring the friction consisted of cleaning the surface of the test sample, as well as the reference surface with a lint free towel and 2-propanol. The dog-bone shaped test sample was attached to a 200 gram sled via double-side tape. The sled was attached to the load cell via wire-core tether, and placed on the reference surface. The test was initiated by the operator and observed in case any issues arose. The force (N) required to pull the sled with the sample vs. travel distance (mm) over an overall distance of 150 mm was measured. The above steps were repeated three times for each side and for each half of all provided specimens (test samples and control samples). Data analysis was conducted by selecting a point approximately halfway through the test (80 mm), giving a comparison between the two materials for dynamic friction as summarized in Table 5 below.

TABLE 5
Dynamic Friction Measurement Test Results

| | | | Average | | | |
|---|---|---|---|---|---|---|
| | Count | Sum | Force (N) | Variance | σ | 2σ |
| C1 | 8 | 62.42 | 7.8 | 2.24194 | 1.4973 | 2.99 |
| R1 | 12 | 40.87 | 3.41 | 1.11657 | 1.0567 | 2.11 |

The average force for the control sample (C1) was measured to be 7.80 +2.99 N, while the test sample (R1) with the PSQ additive exhibited an average force of 3.41 +2.11 N with a P-value of 4.01×10⁻⁷, giving a 95% confidence interval relative to these measurements. Thus, the silicone cable jacket containing the PSQ additive exhibits a lower dynamic friction level than a similar silicone cable jacket without the PSQ additive being present.

One skilled in the art will understand that silicone cable jackets formed according to the teachings of the present disclosure may also have applications outside of medical cable assemblies. These applications may even include uses in cable assemblies where silicones are not currently be used due to low abrasion and cut resistance. Many applications in which the cable jackets and cable assemblies require resistance to exposure to high temperature and/or chemical environments may find use for the silicone cable jackets and assemblies of the present disclosure. Several examples of such applications, include but are not limited to, use in automotive, aerospace, defense, and marine applications, which may benefit from the improved properties of the silicone elastomers loaded with a PSQ additive. This technology creates a strategic advantage for any product that includes a silicone cable jacket or cable assembly because of the ability to bond to the surface of the cable jacket while exhibiting a lubricious and abrasion resistant outer surface.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A silicone cable jacket that exhibits lubricious properties, the cable jacket comprising:
a silicone elastomer; and
a PSQ additive, the PSQ additive being selected from the group of polyalkylsilsesquioxanes, polyarylsilsesquioxanes, polyalkylarylsilsesquioxanes, or a mixture thereof.

2. The cable jacket according to claim 1, wherein the silicone elastomer is a liquid silicone rubber (LSR).

3. The cable jacket according to claim 1, wherein the silicone elastomer is a high consistency rubber (HCR).

4. The cable jacket according to claim 3, wherein the cable jacket further comprises a layer of a liquid silicone rubber (LSR) that at least partially encapsulates the silicone elastomer and is bonded thereto.

5. The cable jacket according to claim 1, wherein the PSQ additive is selected as one from the group of polymethylsilsesquioxane, polyethylsilsesquioxane, polypropylsilsesquioxane, polyphenylsilsesquioxane, polymethylphenylsilsesquioxane, polyethylphenylsilsesquioxane, or a mixture thereof.

6. The cable jacket according to claim 5, wherein the PSQ additive is polymethylsilsesquioxane.

7. The cable jacket according to claim 1, wherein the PSQ additive is incorporated into the cable jacket in an amount within the range of about 10 wt. % to about 30 wt. % based on the overall weight of the cable jacket.

8. The cable jacket according to claim 1, wherein the PSQ additive comprises one or more hydroxyl- or alkoxy-functional groups.

9. The cable jacket according to claim 8, wherein the PSQ additive and the silicone elastomer are cross-linked.

10. The cable jacket according to claim 1, wherein the cable jacket with the PSQ additive exhibits at least a 30% reduction in weight loss in a DIN 53516 test as compared to a similar cable jacket without the PSQ additive.

11. The cable jacket according to claim 1, wherein the cable jacket with the PSQ additive exhibits a lower static and dynamic coefficient of friction (COF) as measured according to ASTM D 1894-14 than a similar cable jacket without the PSQ additive.

12. The cable jacket according to claim 11, wherein the cable jacket with the PSQ additive exhibits a static COF that is at least 25% lower than the static COF than a similar cable jacket without the PSQ additive.

13. The cable jacket according to claim 1, wherein the cable jacket with the PSQ additive exhibits at least a 50% reduction in weight loss in a DIN 53516 abrasion test, at least a 40% lower static coefficient of friction (COF) as measured according to ASTM D 1894-14, and a decrease in tear resistance by more than 15% in an ASTM D 624-00(12) test as compared to a similar cable jacket without the PSQ additive.

14. A cable assembly, the cable assembly comprising:
a cable; and
a cable jacket, wherein the cable jacket comprises
a silicone elastomer; and
a PSQ additive, the PSQ additive being selected from the group of polyalkylsilsesquioxanes, polyarylsilsesquioxanes, polyalkylarylsilses-quioxanes, or a mixture thereof.

15. The cable assembly according to claim 14, wherein the cable assembly passes at least 150 cycles of autoclave conditioning without the occurrence of any bonding defects between the cable jacket and the cable.

16. The cable assembly according to claim 14, wherein the silicone elastomer is a high consistency rubber (HCR) and the PSQ additive is polymethylsilsesquioxane;
wherein the PSQ additive is incorporated into the cable jacket in an amount within the range of about 10 wt. % to about 30 wt. % based on the overall weight of the cable jacket.

17. The cable assembly according to claim 16, wherein the cable jacket further comprises a layer of a liquid silicone rubber (LSR) that at least partially encapsulates the silicone elastomer and is bonded thereto.

18. The cable assembly according to claim 14, wherein the PSQ additive comprises one or more hydroxyl- or alkoxy-functional groups, such that the PSQ additive and the silicone elastomer can be cross-linked.

19. The cable assembly according to claim 14, wherein the cable jacket with the PSQ additive exhibits a lower static and dynamic coefficient of friction (COF) as measured according to ASTM D 1894-14 and at least a 30% reduction in weight loss in a DIN 53516 test as compared to a similar cable jacket without the PSQ additive;
wherein the static COF exhibited by the cable jacket with the PSQ additive is at least 25% lower than the static COF exhibited by the similar cable jacket without the PSQ additive.

20. The cable assembly according to claim 14, wherein the cable assembly is used in a medical, automotive, aerospace, defense, or marine application.
